(19) United States
(12) Patent Application Publication
(10) Pub. No.: US 2025/0231818 A1
(43) Pub. Date: Jul. 17, 2025

(54) Effective Monolith Development Using Microservices

(71) Applicant: Dell Products, L.P., Hopkinton, MA (US)

(72) Inventor: Ruben Michel, Hopkinton, MA (US)

(21) Appl. No.: 18/412,789

(22) Filed: Jan. 15, 2024

(51) Int. Cl. G06F 9/50; G06F 21/44

(52) U.S. Cl. CPC G06F 9/5077; G06F 21/44

(57) ABSTRACT

Effective monolith development using microservices is enabled by including a servlet in a microservice component to be developed and a mocking microservice to emulate response of the monolith during development. Functions to be incorporated in a monolith are developed as microservices, and then integrated into the monolith. The microservice component includes a coordinating Enterprise Archive (EAR) containing a servlet to receive commands to the microservice after the microservice component is developed and integrated into the monolith. The microservice includes a Development EAR (Dev EAR) which also includes the servlet to receive commands during development. The microservice component includes a mocking subsystem that is used to provide responses to the Dev EAR during development, and a services EAR which implements commands from the Dev EAR on the monolith when the microservice is integrated into the monolith.

### FIELD

This disclosure relates to computing systems and related devices and methods, and, more particularly, to a method and apparatus for effective monolith development using microservices.

### SUMMARY

The following Summary and the Abstract set forth at the end of this document are provided herein to introduce some concepts discussed in the Detailed Description below. The Summary and Abstract sections are not comprehensive and are not intended to delineate the scope of protectable subject matter, which is set forth by the claims presented below.

All examples and features mentioned below can be combined in any technically possible way.

A monolith consists of a client communicating with a server, which in turn delegates persistence to a database. Similarly, a microservice consists of the same three components operating on a far smaller scale. In a microservices architecture, multiple interacting microservices comprise the application.

The monolith's main advantage is simplicity, consisting of just three components, the client, the server, and the database. The monolith's main disadvantage is that, for large applications, those three components become prohibitively large. Consequently, compilation, debugging, deployment, and startup slow dramatically. For example, typically, the entire monolith's source code resides in a single large repository maintained in a version control system. One example commercially available version control system is GitHub™. Several commercial version control systems can readily handle such large repositories, but not all version control systems are equally capable. Further, occasionally, large, cloned repositories become irreparably corrupted, which requires the clone to need to be recreated leading to frustration and productivity loss. For example, when a developer looks to work on an aspect of the monolith source code, the developer will need to clone the source code from the version control system to obtain a copy of the source code. For a large monolith, this can take 20-30 minutes or longer. In the event of an error, this process may need to be repeated. Hence, it can take up to an hour simply to obtain a copy of the monolith's source code before any work is done. At the end of the day, the source code will need to be checked back into the version control system, which also can take a significant amount of time. Accordingly, as the monolith increases in size, development work for new features or work to correct bugs and other errors becomes increasingly time consuming.

Additionally, whenever the monolith (server) is changed, the corresponding client needs to be changed. In some environments, aspects of the client are automatically created from the server, but any small change to the server requires the entire client to be rebuilt (rebuild on change). As the monolith increases in size, the client likewise increases in size and the client rebuild process takes longer to implement. For example, for a large monolith, it may take 15 minutes or more to rebuild the client whenever a change is implemented to the monolith. This further exacerbates the problems associated with working directly on the monolith.

In contrast, since microservices are small, their development is rapid and efficient. Specifically, a microservices architecture is a design pattern in which each microservice is just one small piece of a bigger overall system. Each microservice performs a particular task or small set of tasks which contributes to the overall end result of the set of microservices that are used to implement a particular application. Since microservices are small discrete code packages, it is possible to quickly and efficiently check the source code out of and back into a version control system, which makes it much easier to work on a microservice than working directly on the monolith. Likewise, building a client for the microservice is also much faster, since the client only needs to be built from the code contained in the microservice, and hence is much smaller and faster to rebuild on change.

The advantages associated with development of microservices are offset, however, when a significant number of microservices need to be combined to replicate the functionality of the monolith. Specifically, because the microservices implement discrete functions, using a microservice architecture to replicate the monolith results in considerable complexities of microservice deployment, orchestration, and error handling. For example, to implement an application using microservices, the overall tasks of the application are broken down into sub-tasks, and each sub-task or small set of sub-tasks is implemented as a microservice. When a microservice performs its tasks, it then provides the output to a subsequent microservice for further processing. To implement this handoff between microservices, a messaging protocol is required. Further, the services need to be deployed such that there are sufficient instances of each microservice to enable the overall application to handle the intended workload, and the microservices need to be orchestrated to work together. In instances where the different microservices take different amounts of time to startup, orchestration of the multiple microservices can become difficult. All this adds considerable complexity, such that replicating a large monolith using a microservices architecture may offset any efficiencies gained by the developmental benefits.

According to some embodiments, a method and apparatus for effective monolith development using microservices is provided. Specifically, according to some embodiments, a method and apparatus for enabling functions to be developed as microservices is provided, such that the developed microservices are configured to be deployable and directly integrated into a monolith once development of the microservice has been completed. In some embodiments, the container of the server portion of a microservice to be developed includes a coordinating Enterprise Archive (EAR) containing a servlet to receive commands from the monolith client after the microservice component is developed and integrated into the monolith. The microservice includes a Development EAR (Dev EAR) which includes the code to be developed and also includes a servlet to receive commands during both development and regular usage, after the microservice component is integrated into the monolith. The microservice component includes a services EAR which implements commands from both the coordinating EAR and the Dev EAR when the microservice is integrated into the monolith.

The Dev EAR includes a mocking subsystem that is used instead of the services EAR during development of the functionality of the Dev EAR. By providing the Dev EAR with a servlet to receive client commands during development, it is possible to implement development work on the microservice without accessing the higher levels of the monolith. By including a mocking subsystem as part of the Dev EAR to mock the services EAR during development, it is possible to implement development work on the microservice without accessioning the lower levels of the monolith. Accordingly, it is possible to implement monolith development work by working on a microservice without cloning the monolith from the version control system, thereby achieving the benefits of enabling monolith development work to be implemented by working on a microservice. By including the communication EAR and the services EAR in the developed microservice, it is possible to easily convert the microservice such that the Dev EAR delegates to the services EAR rather than to the mocking subsystem, to thus enable the developed microservice to be integrated into the monolith.

In some embodiments, a method of monolith development using microservices, includes creating a container including a coordinating Enterprise Archive (EAR), a Development EAR (Dev EAR), and a services EAR, the coordinating EAR including a first servlet to accept calls from a monolith client and being configured to delegate to both the development EAR and to the services EAR, the Dev EAR including a second servlet to accept calls from a Dev EAR client, the Dev EAR being configured to delegate to the services EAR, developing functionality of the Dev EAR as a mocking microservice independent of the both the coordinating EAR and the services EAR, the mocking microservice having a set of methods configured to delegate to a mocking subsystem rather than to the services EAR while developing the functionality of the Dev EAR, and after developing the functionality of the Dev EAR, enhancing the Dev EAR to run as an integrated microservice within the container by configuring the set of methods to delegate to the services EAR instead of delegating to the mocking subsystem.

In some embodiments, the second servlet is configured to accept calls from the Dev EAR client both during development of functionality of the Dev EAR and after the Dev EAR has been enhanced to run as the integrated microservice within the container. In some embodiments, the second servlet is also configured to accept calls from the monolith client after the Dev EAR has been enhanced to run as the integrated microservice within the container. In some embodiments, the method further includes intercepting calls to the second servlet and delegating authentication of the calls by the Dev EAR to a monolith authentication service.

In some embodiments, the mocking subsystem is configured to provide responses mocking the services EAR when delegated to by the methods of the Dev EAR.

In some embodiments, the method further includes creating the Dev EAR client while developing the functionality of the Dev EAR as the mocking microservice, and integrating the Dev EAR client into the monolith client in connection with enhancing the Dev EAR to run as the integrated microservice.

In some embodiments, a method of monolith development using microservices, includes creating a container including a coordinating Enterprise Archive (EAR), a Development EAR (Dev EAR), and a services EAR, the coordinating EAR including a first servlet to accept calls from a monolith client and being configured to delegate to both the development EAR and to the services EAR, the Dev EAR including a second servlet to accept calls from a Dev EAR client, the Dev EAR being configured to delegate to the services EAR, developing functionality of the Dev EAR as a semi-integrated microservice independent of the coordinating EAR, the semi-integrated microservice having a set of methods configured to delegate to the services EAR while developing the functionality of the Dev EAR, and after developing the functionality of the Dev EAR, enhancing the Dev EAR to run as an integrated microservice within the container to include the coordinating EAR.

In some embodiments, the second servlet is configured to accept calls from the Dev EAR client both during development of functionality of the Dev EAR and after the Dev EAR has been enhanced to run as the integrated microservice within the container. In some embodiments, the second servlet is also configured to accept calls from the monolith client after the Dev EAR has been enhanced to run as the integrated microservice within the container. In some embodiments, the method further includes intercepting calls to the second servlet and delegating authentication of the calls by the Dev EAR to a monolith authentication service.

In some embodiments, the services EAR is configured to execute functions when delegated to by the methods of the Dev EAR.

In some embodiments, the method further includes creating the Dev EAR client while developing the functionality of the Dev EAR as the mocking microservice, and integrating the Dev EAR client into the monolith client in connection with enhancing the Dev EAR to run as the integrated microservice.

### BRIEF DESCRIPTION OF THE DRAWINGS

FIG. 1 is a block diagram of an example software application implemented as a monolith, according to some embodiments.

FIG. 2 is a block diagram of an example software application implemented using a microservices architecture, according to some embodiments.

FIG. 3 is a block diagram of an example process of effective monolith development using microservices, according to some embodiments.

FIG. 4 is a block diagram of an example software application implemented as a monolith in which functions developed as microservices have been integrated into the monolith, according to some embodiments.

FIG. 5 is a Unified Modeling Language (UML) container diagram of an example microservice configured to be developed independent of a monolith and subsequently integrated into the monolith, according to some embodiments.

FIG. 6 is a UML class diagram of an example development Enterprise Archive (EAR) of FIG. 5 implemented using a template method design pattern, according to some embodiments.

FIG. 7 is a maven profile configured to merge the mock-ejb folder into the ejb folder of FIG. 6, while ignoring the impl-ejb folder, to enable the mocking subsystem to simulate a hosted deployment, according to some embodiments.

FIG. 8 is a block diagram of a microservice development environment, including a microservice container having a Dev EAR, and a class diagram of the Dev EAR during development, according to some embodiments.

FIG. 9 is a block diagram of a deployment environment, in which the developed microservice is included in a monolith, and showing a class diagram of the Dev EAR after deployment, according to some embodiments.

FIG. 10 is a block diagram of a semi-integrated microservice development environment, including a microservice container having both a Dev EAR and a services EAR, and a class diagram of the Dev EAR during development, according to some embodiments.

### DETAILED DESCRIPTION

Aspects of the inventive concepts will be described as being implemented using particular types of containers and programming languages. Such implementations should not be viewed as limiting. Those of ordinary skill in the art will recognize that there are a wide variety of implementations of the inventive concepts in view of the teachings of the present disclosure.

Some aspects, features and implementations described herein may include machines such as computers, electronic components, optical components, and processes such as computer-implemented procedures and steps. It will be apparent to those of ordinary skill in the art that the computer-implemented procedures and steps may be stored as computer-executable instructions on a non-transitory tangible computer-readable medium. Furthermore, it will be understood by those of ordinary skill in the art that the computer-executable instructions may be executed on a variety of tangible processor devices, i.e., physical hardware. For ease of exposition, not every step, device or component that may be part of a computer or data storage system is described herein. Those of ordinary skill in the art will recognize such steps, devices, and components in view of the teachings of the present disclosure and the knowledge generally available to those of ordinary skill in the art. The corresponding machines and processes are therefore enabled and within the scope of the disclosure.

The terminology used in this disclosure is intended to be interpreted broadly within the limits of subject matter eligibility. The terms “logical” and “virtual” are used to refer to features that are abstractions of other features, e.g., and without limitation, abstractions of tangible features. The term “physical” is used to refer to tangible features, including but not limited to electronic hardware. For example, multiple virtual computing devices could operate simultaneously on one physical computing device. The term “logic” is used to refer to special purpose physical circuit elements, firmware, and/or software implemented by computer instructions that are stored on a non-transitory tangible computer-readable medium and implemented by multi-purpose tangible processors, and any combinations thereof.

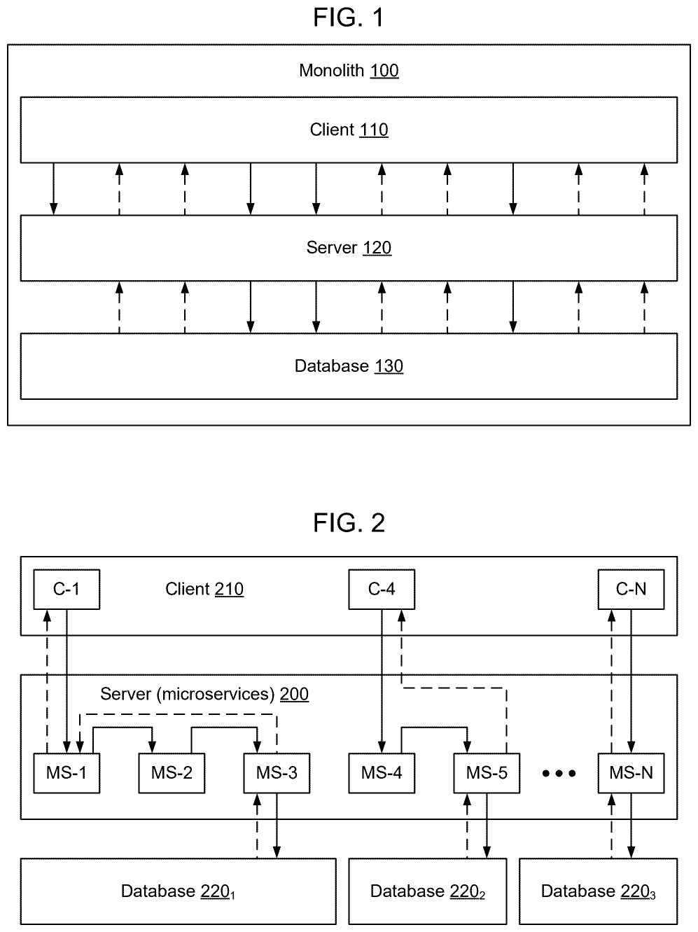

FIG. 1 is a block diagram of an example software application implemented as a monolith 100, including a client 110, a server 120, and a database 130, according to some embodiments. As shown in FIG. 1, when an application is implemented as a monolith 100, the application and all its functionality is integrated. Portions of the client 110 that interact with the functionality of the server 120 are automatically created from the server 120, to enable the client 100 to access the functionality of the server. The database 130 stores data under the direction of the server 120. Guaranteeing the integrity of the database's content is critical. Because the server 120 that interacts with the database 130 is implemented within the monolith, it is possible to ensure that a single large schema is used to interact with the database. For example, consider a monolith configured to implement a Relational Database Management System (RDBMS). Each RDBMS supports constraining the data through domain constraints, uniqueness constraints, entity integrity constraints, and referential integrity constraints. The database administrator specifies the appropriate constraints, and the RDBMS obediently enforces those constraints. By implementing the application that interacts with the database, such as a RDBMS as a monolith, it is possible to ensure that the aspects of the application consistently enforce the same set of constraints. Hence, there are operational advantages to using a monolith in certain instances, such as where the application that is being implemented by the monolith is required to interact with a database 130.

FIG. 2 is a block diagram of an example software application implemented using a microservices architecture, according to some embodiments. As shown in FIG. 2, in a microservices architecture individual microservices MS-1, MS-2, MS-3 . . . MS-N are individually created, and groups of microservices are orchestrated to work together to implement particular functions of the server 200. For example, separate design teams may be tasked with creation of each of the microservices or sets of microservices, and may thus implement the microservices using different programming languages depending on the preference of the design team. Individual clients C1, C4, C-N are also created from the microservices, which may be integrated into a larger client 210. When microservices are used to interact with a database, the microservices architecture extends autonomy to each microservice-development team to select a preferred database technology. Consequently, different database technologies 2201, 2202, 2203 might be selected for the database, such that guaranteeing integrity across the entire dataset of the database is typically infeasible, which makes development of an application such as a RDBMS using a microservices architecture difficult. Also, in instances where different databases 2201, 2202, 2203 are different sizes, it might take longer for one of the microservices to start than it takes the other microservices to start. Thus, orchestrating startup of the microservices in a microservices architecture can become challenging.

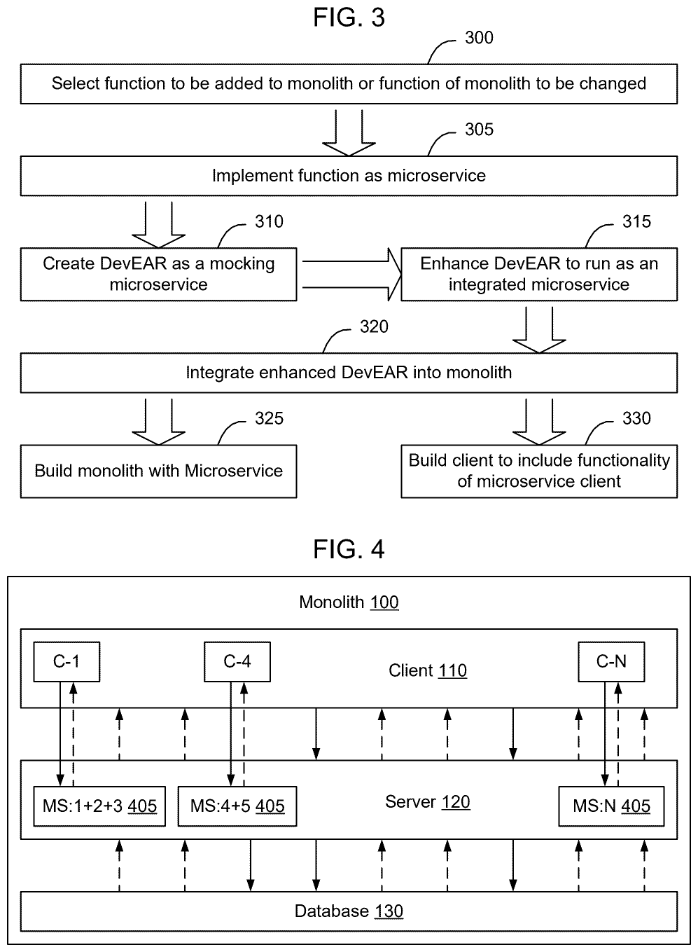

FIG. 3 is a block diagram of an example process of effective monolith development using microservices, according to some embodiments. As shown in FIG. 3, in some embodiments a function to be added to a monolith is selected for development. Equivalently, a function of the monolith that needs to be changed may be selected for development (block 300). Development of the function is then implemented by developing a microservice (block 305). In some embodiments, the microservice is implemented by creating the Dev EAR initially as a mocking microservice (block 310) in which the classes of the Dev EAR delegate to a mocking subsystem. Then, after the functionality of the microservice is finalized, the microservice is converted to run as an integrated microservice by enhancing the Dev EAR to delegate to the services EAR rather than to the mocking subsystem (block 315).

The enhanced microservice is then integrated into the monolith (block 320). For example, in some embodiments the microservice is included in the monolith build, thus integrating the microservice into the monolith during the next build of the monolith (block 325). Once integrated into the monolith, the change to the monolith functionality will cause the monolith client to be rebuilt (rebuild on change) (block 330), optionally reusing the client code created during development of the microservice. By enabling development to be done in the context of developing a microservice, it is possible to take advantage of the efficiencies associated with microservice development, such as reduced overhead associated with moving the source code into and out of the Version Control System, and reduced time required to build the client whenever changes are implemented on the microservice source code. By configuring the developed microservice to enable the microservice to be directly integrated into the monolith, it is possible to minimize the amount of work that needs to be done within the monolith after the microservice is converted to operate as an integrated microservice.

FIG. 4 is a block diagram of an example software application implemented as a monolith 100 in which functions 405 developed as microservices have been integrated into the monolith 100, according to some embodiments. As shown in FIG. 4, once a function 405 has been developed as a microservice using the process shown in FIG. 3, the function 405 is able to be integrated into the functionality of the monolith 100. Accordingly, all the database constraints associated with the monolith architecture of FIG. 1 are able to be enforced, thus overcoming some of the shortcomings of the microservices architecture of FIG. 2. Further, because development of the functions 405 is able to be implemented by developing the functions 405 as microservices, a majority of the development work on the functions 405 is able to be implemented without working on the monolith, thus eliminating the inefficiencies and inconveniences associated with working directly on the monolith.

### Server Solution

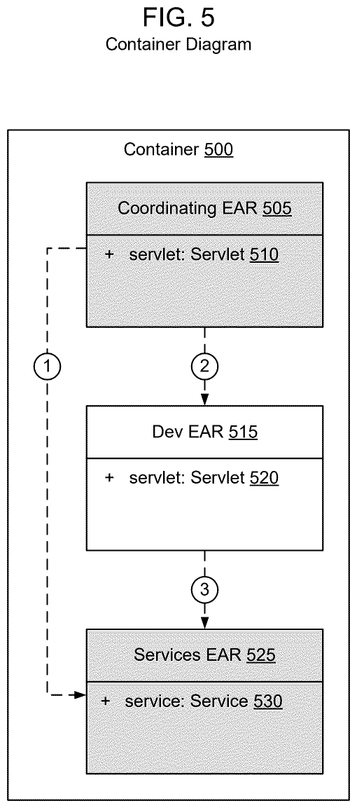

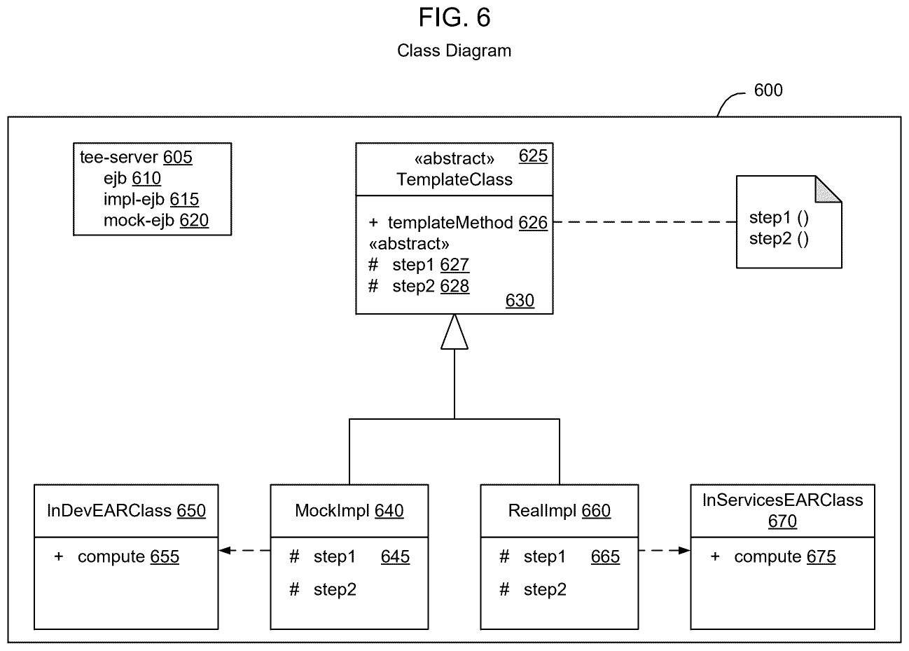

FIG. 5 is a Unified Modeling Language (UML) container diagram of an example microservice configured to be developed independent of a monolith and subsequently integrated into the monolith, according to some embodiments, and FIG. 6 is a UML diagram of an example Development Enterprise Archive (Dev EAR) of FIG. 5 implemented using a template method design pattern, according to some embodiments. Although FIGS. 5 and 6 will describe some implementations in which a microservice is implemented as a Jakarta Enterprise Edition (JEE) server (formerly Java Enterprise Edition), it should be understood that the approaches described herein extend to any modularized monolith where module dependencies are properly respected. Specifically, the approaches described herein work in environments where a server has different modules, and the calls between the modules are well defined and the order of calls between the modules is respected. For example, the monolith may rely on the popular Spring framework, rather than JEE. Moreover, the monolith may be a polyglot still running on a Java Virtual Machine (JVM) but using several JVM languages. Furthermore, the monolith may not run on a JVM at all, but may instead use multi-language infrastructures, such as COM (Component Object Module by Microsoft™), CORBA (Common Object Request Broker Architecture), ICE (Internet Communications Engine), or SOAP (Simple Object Access Protocol). Accordingly, although some embodiments are described in which an example sever is implemented using JEE, it should be understood that this description is merely included to provide on example of how a microservice may be created to be subsequently integrated into a monolith.

FIG. 5 is a Unified Modeling Language (UML) container diagram of an example server 500 including three Enterprise Archives (EARs) 505, 515, 525. A software provider packages an application or module into an archive file. In FIG. 5, there are three enterprise archives: a Coordinating EAR 505, a Development EAR 515 (referred to herein as Dev EAR), and a service EAR 525.

At the top, the Coordinating EAR 505 is armed with a Servlet 510 that accepts client calls from the monolith client once the container 500 is integrated into the monolith. The Coordinating EAR 505 may be developed by a different development group (a development group other than the group that is working on the Dev EAR), and accordingly is shaded in FIG. 5. At the bottom, the Services EAR 525 provides basic services 530 to all EARs 505, 515 of the container 500. The Services EAR 525 may also be developed by a different development group, and accordingly is also shaded in FIG. 5. Notice that the Services EAR 525 has no Servlet, and therefore cannot accept client calls. In the center, the Dev EAR 515 provides the new functionality of the microservice that is to be developed, and accordingly is not shaded. Significantly, the Dev EAR 515 is also armed with a Servlet 520, and consequently can also accept client calls. In FIG. 5, the EAR dependencies are from top to bottom. For example, the Coordinating EAR 505 can call into both the Dev EAR 515 and the Services EAR 525, as shown by dashed arrows 1 and 2 respectively. However, the Dev EAR cannot call into the Coordinating EAR. The Dev EAR 515 can, however, call into the Services EAR 525 as shown by dashed arrow 3. In UML, a dashed line indicates delegation, which indicates that the coordinating EAR can delegate to both the Dev EAR and to the services EAR, and that the Dev EAR can delegate to the services EAR.

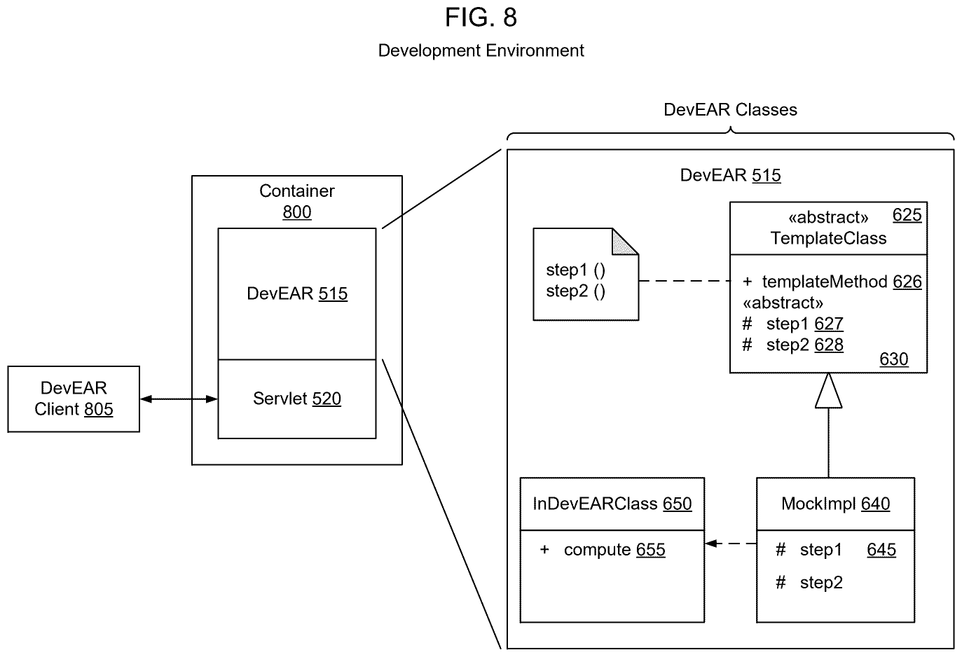

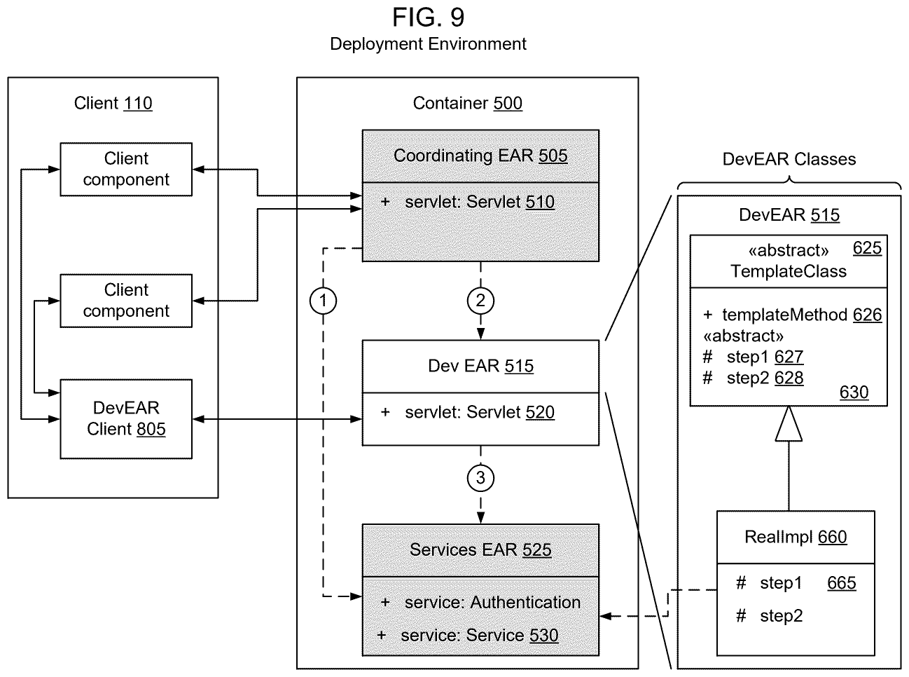

According to some embodiments, the Dev EAR 515 is first developed as a mocking microservice, independent of both the Coordinating EAR 505 and the Service EAR 525. The mocking microservice includes a mocking subsystem that provides responses when delegated to by the classes of the Dev EAR 515 that are being developed. When development of functionality of the Dev EAR 515 is completed, the Dev EAR 515 is enhanced to run as an integrated microservice inside the JEE Container, as indicated in FIG. 5. Then, the Coordinating EAR can call both the Dev EAR and the Services EAR, and the Dev EAR can call the Services EAR. FIGS. 8 and 9 provide additional details, and show a development environment of the Dev EAR during development of the functionality of the Dev EAR (FIG. 8), and the deployment environment after the microservice has been integrated into the monolith (FIG. 9).

FIG. 6 is a UML class diagram of an example development Enterprise Archive (EAR) of FIG. 5 implemented using a template method design pattern, according to some embodiments. A “template method design pattern” as used herein, refers to a behavioral pattern in object-oriented programming, in which the template method is in a superclass (also referred to herein as a base class), which is usually an abstract superclass, and defines the skeleton of an operation in terms of a number of high-level steps. The template method is implemented as a method and contains code for the parts of the overall algorithm that are invariant. For example, in FIG. 5 the template class includes two high-level steps, step1, and step2. The steps themselves are implemented by additional helper methods in the same class as the template method. The helper methods may be either abstract methods, in which case subclasses are required to provide concrete implementations, or hook methods, which have empty bodies in the superclass. Subclasses of the base class fill in the variant parts of the template with specific algorithms that vary from one subclass to another. Thus, the template method defines the overall structure of the operation, while allowing subclasses to refine, or redefine, certain steps.

In the example class diagram of FIG. 6, as illustrated in the top left corner of FIG. 6, the tee-server folder 605 contains three subfolders, an ejb subfolder 610, an impl-ejb subfolder 615, and a mock-ejb subfolder 620. The ejb subfolder contains the Enterprise Java Bean (ejb) layer. The TemplateClass class 625 resides there. The impl-ejb subfolder 615 contains additional ejb classes for running as an integrated microservice, once the microservice has been integrated into the monolith. The RealImpl class 660 resides in the impl.ejb folder 615. The mock-ejb subfolder 620 contains additional ejb classes for running as a mocking microservice. The MockImpl class 640 and the InDevEARClass class 650 reside in the mock-ejb subfolder 620. The InDevEARClass 650, in some embodiments, implements the mocking subsystem that is delegated to by the MockImpl class 640 during development of the functionality of the microservice.

Significantly, the InServicesEarClasss class 670 resides in the Services EAR 525 of FIG. 5, not in Dev EAR 515. Since RealImpl 660 runs inside the JEE Container 500, RealImpl can invoke methods in the InServicesEarClass class 670 of the services ear 525 (e.g. service 530); MockImpl 640 cannot, because the mocking microservice runs isolated. Other subfolders under tee-server 605, such as the ear and web subfolders, are omitted since they are unrelated to this exposition.

FIGS. 8 and 9 show the microservice during development and after deployment. As shown in FIG. 8, during development the Dev EAR 515 includes the TemplateClass class 625 and the subclass MockImpl 640, which delegates to the mocking subsystem 650. When the MockImpl 640 issues a call to the mocking subsystem 650, the mocking subsystem provides a response to the call. As an example, assume the functionality of the TemplateClass 625 was designed to determine if a hard disk drive was operational. The mocking subsystem 650, in this example, would be configured to receive a call from the MockImpl 640 requesting the mocking subsystem 650 to test the operationality of a particular hard disk drive. In response, the mocking subsystem 650 would provide a response with the expected format. Thus, rather than send an actual request via the services EAR 525 to have the services EAR send an actual request to the microcode to check the actual status of an actual hard disk drive, the mocking subsystem 650 enables a mock response to be provided to the Dev EAR. Providing a mocked response is often much quicker than waiting for an actual response from the services EAR and, additionally, is able to be implemented without requiring the services EAR to be included in the container 800 of the development environment.

As shown in FIG. 9, once the development of the functionality of the microservice is completed, and the microservice is integrated into the monolith, the classes of the Dev EAR are changed such that the Dev EAR includes only the template class 625 and the Real Impl class 660. The Real Impl class 660 is able to delegate to the services EAR 525 as indicated by the dashed line (dashed lines are used to indicate delegation in UML).

Referring back to FIG. 6, in the example Template Method Design Pattern Diagram shown in FIG. 6, there are three example classes: TemplateClass class 625 along with its two derived classes MockImpl 640 and RealImpl 660. The solid arrow with the large arrowhead identify the MockImpl class 640 and RealImpl class 660 as inherited classes of the TemplateClass in UML. MockImpl 640 and RealImpl 660 implement the same methods. Collectively, these three classes realize the Template Method Design Pattern 600. The TemplateClass class 625 defines the method templateMethod 626, that first invokes the step1 method 627 and thereafter the step2 method 628. The functionality that is being developed is implemented within TemplateClass class 625. In the example shown in FIG. 5, within the TemplateClass class 625, there are two protected methods 627, 628 which are abstract, having just a declaration but no definition.

The step1 and step2 methods 627, 628 are defined independently in both the MockImpl class 640 and the RealImpl class 660. The MockImpl class 640 delegates to other classes within the mock-ejb folder 620, such as the InDevEarClass class 650 which, as described herein, is used to implement the mocking subsystem. In contrast, the RealImpl class 660 can delegate to classes outside the impl-ejb folder 615, such as the InServicesEarClass class 670, which resides in the Services EAR 525.

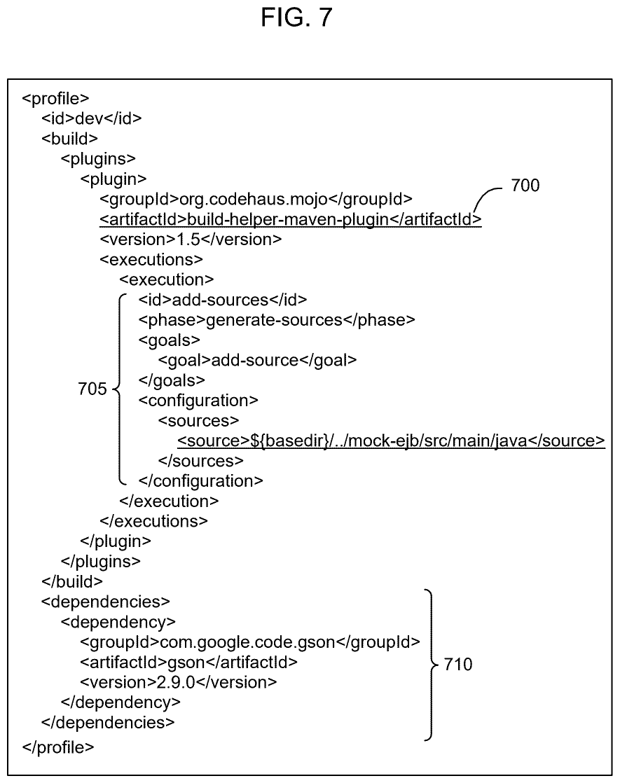

When developing Dev EAR 515 as a mocking microservice, the mock-ejb folder 620 is merged into the ejb folder using the Maven profile of FIG. 7, while ignoring the impl-ejb folder. Significantly, since the code in the impl-ejb folder is ignored, that code need not even compile. Therefore, developing the impl-ejb code can be delayed until much later, when starting monolith integration.

FIG. 7 is a Maven profile configured to merge the mock-ejb folder 620 into the ejb folder 610 of FIG. 6, while ignoring the impl-ejb folder 615, to enable the Dev EAR 515 to use the mocking subsystem to simulate a hosted deployment in a mock-hosted-ejb directory, according to some embodiments. Maven is a build automation tool used primarily for Java projects, but which can also be used to build and manage projects written in various other languages. Although FIG. 7 shows an example Maven profile, it should be understood that other build automation tools may be used as well.

The Maven profile shown in FIG. 7 delegates to the build-helper-maven-plugin (line 700) to merge the mock-ejb folder 620 into the ejb folder 610 (lines 705). Additionally, the Maven profile specifies dependencies specific to MockImpl 640, such as the gson dependency (lines 710), rather than specifying such dependencies globally.

In some development projects, it may be advantageous to provide more than one mocking subsystem. For example, some monoliths are designed to run in multiple environments such as a hosted environment, in which the monolith runs on a Windows or Linux server separate from the storage system, and an embedded environment in which the monolith runs directly on the storage system. Accordingly, in some embodiments multiple mocking subsystems may be provided. For example, instead of having a single mock-ejb folder 620 the tee-server directory 604 may include both a mock-hosted-ejb directory as well as a mock-embedded-ejb directory.

When developing Dev EAR as an integrated microservice, a maven profile similar to the profile shown in FIG. 7 would merge the impl-ejb folder 615 into the ejb folder, now ignoring the mock-ejb 620 folder.

Significantly, the crux of the functionality of the Dev EAR 515 is implemented by methods such as the templateMethod 626 in the TemplateClass class 625. For the mocking microservice, that functionality is complemented by mocking classes such as MockImpl 640. Correspondingly, for the integrated microservice, that functionality is complemented by classes such as RealImpl 660.

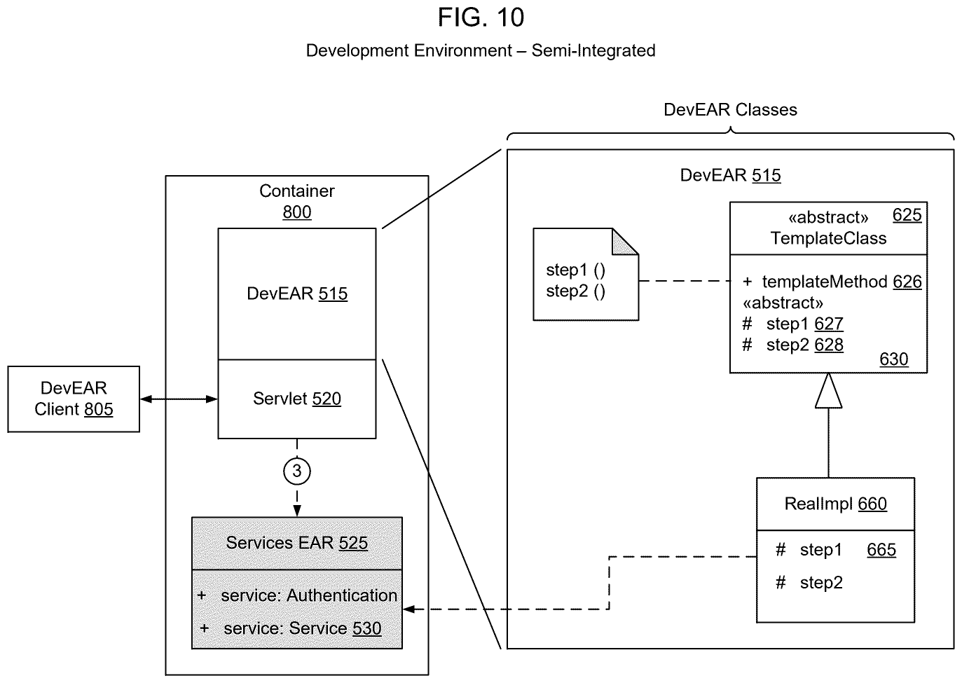

In certain cases, running the Dev EAR 515 while mocking the Services EAR 625 is simple. For example, if the functionality being developed requires only a few calls to be mocked by the mocking subsystem, it may be straightforward to create the mocking subsystem InDevEARClass 650. In other cases, for example where there are a large number of calls to be mocked, creating the mocking subsystem to mock the response of the Services EAR 625 is tedious. In instances where mocking the services EAR 625 is difficult, it is possible to develop the Dev EAR 615 as a semi-integrated microservice that delegates to the Services EAR but ignores the Coordinating EAR. An example semi-integrated microservices development environment is shown in FIG. 10. Having to delegate to the Services EAR 625 likely reduces productivity but obviates the need for mocking. Specifically, as shown in FIG. 10, in a semi-integrated microservice development environment, development work is implemented directly on the RealImpl 660, which delegates to the services EAR 525.

For example, as shown in FIG. 10, in a semi-integrated development environment, since the calls of Dev EAR 515 are implemented on the services EAR 525, a portion of the monolith required to implement the services EAR 525 is required to be incorporated into the development environment. However, it is possible to incorporate only a portion of the monolith, thus still reducing the amount of source code that needs to be checked out/in to the version control system. Further, the amount of source code that is used to implement each layer of the monolith increases as you get further toward the top. For example, in FIG. 5 the coordinating EAR layer 505 is often much heavier than the services EAR 525. Accordingly, being able to implement development of the Dev EAR 515 without requiring inclusion of the coordinating EAR 505 provides significant benefits to the development process.

### Client

A large monolith typically has a large server and a correspondingly large client. Building the large client is painfully slow, particularly when supporting rebuild-on-change. Furthermore, the rebuild-on-change feature, critical for GUI development, often operates too slowly.

When developing the Dev EAR's client, the entire GUI development environment is still necessary. However, a mocking client requires only pertinent client code; all other client code is excised. Although small, the mocking client still features significant logic, which is later reused intact in the monolith's client. Fortunately, the mocking client is typically small, reflecting the specific functionality of the Dev EAR 515. Consequently, build times and rebuild-on-change times for the Dev EAR client 515 are fast.

### Dev EAR Servlet Call Security

In typical monolith designs, clients always connect to the server through the Coordinating EAR's 505 Servlet 510. As shown in FIG. 5, in the microservice, the Dev EAR 515 also includes a servlet 520, and the client connects directly to the Dev EAR 515, through the Dev EAR's Servlet 520. As shown in FIG. 9, once the developed microservice 500 is integrated into the monolith 100, the Dev EAR client 805 continues to issue calls to the servlet 520 of the Dev EAR 515. Calls from other aspects of the monolith client 110 may be passed to the Dev EAR 515 via the Dev EAR client 805 or through the servlet 510 of the coordinating EAR 505.

Enabling the client to connect directly to Dev EAR 515 is not problematic during the development phase, when calls to the Dev EAR are implemented on the mocking implementation 640 (FIG. 8). However, once the microservice is integrated into the monolith (FIG. 9), the client calls will need to be authenticated. According to some embodiments, the Dev EAR features a JAX-RS (Jakarta API for RESTful Web Services) Container Request Filter, which intercepts all incoming calls. When a call arrives, the Container Request Filter immediately delegates authentication to the monolith's Authentication Service. That incoming call can only proceed if authentication succeeds but is rejected otherwise. Consequently, by including a container request filter in the Dev EAR 515, it is possible to maintain authentication at the same level as the monolith. Although FIGS. 9 and 10 show the service configured to delegate authentication to the monolith's Authentication Service as residing in the Services EAR 525, it should be understood this service may reside within another EAR within container 500 depending on the implementation.

### Scaling Out the Microservices

A key benefit of the microservices architecture is scaling out overextended microservices. Fortunately, many JEE containers support dynamically starting up new processes in the same or remote computers. For example, the Wildfly™ application server JEE container features the domain configuration mode, which enables on the fly startup of new processes. Once the new process has started, relevant EARs can be dynamically deployed into that process. For example, a new Windows™ or Linux™ process may be started, and then an EAR may be deployed into that newly started process. An API-Gateway may then be used to direct calls to the running processes according to various strategies, such as round robin, least latency time, least connections, random, or other call distribution strategy.

### Managing the Monolith's Source Code

During development of the functionality associated with the template class 625 of the Dev EAR 515, because the coordinating EAR 505 is not required to be used and the services EAR 525 is replaced with the mocking microservice 640, it is not necessary to clone the entire monolith from the version control system. Rather, the EAR 500 can be separately maintained in the version control system. Since the Dev EAR source code is significantly smaller than the source code of the monolith, this greatly reduces the amount of time it takes to check out and check in code from the version control system, and reduces the likelihood that the local code will be corrupted. Only when developing Dev EAR as an integrated microservice or as a semi-integrated microservice is additional source code needed.

### The Build

A large monolith requires a correspondingly complex build. To accomplish its various tasks, the monolith's client and server need to communicate, often using different programming languages. To reduce runtime errors, that communication should typically be strongly typed, requiring a code generator. In one approach, client code is generated directly from server code. Alternatively, the code generator emits both client and server code from a specification written in Interface Definition Language, IDL. In any case, typically, the monolith's build invokes that code generator only once.

However, mocking microservices and semi-integrated microservices are built independently of the monolith. Therefore, both a custom build and a custom code generator are required. Finally, the monolith's build must invoke the integrated microservice's build; that can be readily accomplished with Maven's hierarchical structure. The hierarchical structure enables the monolith build to include a declaration to also invoke the microservice's build, such that the microservice is built in connection with the monolith build.

The methods described herein may be implemented as software configured to be executed in control logic such as contained in a CPU (Central Processing Unit) or GPU (Graphics Processing Unit) of an electronic device such as a computer. In particular, the functions described herein may be implemented as sets of program instructions stored on a non-transitory tangible computer readable storage medium. The program instructions may be implemented utilizing programming techniques known to those of ordinary skill in the art. Program instructions may be stored in a computer readable memory within the computer or loaded onto the computer and executed on computer's microprocessor. However, it will be apparent to a skilled artisan that all logic described herein can be embodied using discrete components, integrated circuitry, programmable logic used in conjunction with a programmable logic device such as a FPGA (Field Programmable Gate Array) or microprocessor, or any other device including any combination thereof. Programmable logic can be fixed temporarily or permanently in a tangible non-transitory computer readable medium such as random-access memory, a computer memory, a disk drive, or other storage medium. All such embodiments are intended to fall within the scope of the present invention.

Throughout the entirety of the present disclosure, use of the articles “a” or “an” to modify a noun may be understood to be used for convenience and to include one, or more than one of the modified nouns, unless otherwise specifically stated. The term “about” is used to indicate that a value includes the standard level of error for the device or method being employed to determine the value. The use of the term “or” in the claims is used to mean “and/or” unless explicitly indicated to refer to alternatives only or the alternatives are mutually exclusive, although the disclosure supports a definition that refers to only alternatives and to “and/or.” The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and also covers other unlisted steps.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of monolith development using microservices, comprising:
creating a container including a coordinating Enterprise Archive (EAR), a Development EAR (Dev EAR), and a services EAR, the coordinating EAR including a first servlet to accept calls from a monolith client and being configured to delegate to both the development EAR and to the services EAR, the Dev EAR including a second servlet to accept calls from a Dev EAR client, the Dev EAR being configured to delegate to the services EAR;
developing functionality of the Dev EAR as a mocking microservice independent of the both the coordinating EAR and the services EAR, the mocking microservice having a set of methods configured to delegate to a mocking subsystem rather than to the services EAR while developing the functionality of the Dev EAR; and
after developing the functionality of the Dev EAR, enhancing the Dev EAR to run as an integrated microservice within the container by configuring the set of methods to delegate to the services EAR instead of delegating to the mocking subsystem.

2. The method of claim 1, wherein the second servlet is configured to accept calls from the Dev EAR client both during development of functionality of the Dev EAR and after the Dev EAR has been enhanced to run as the integrated microservice within the container.

3. The method of claim 2, wherein the second servlet is also configured to accept calls from the monolith client after the Dev EAR has been enhanced to run as the integrated microservice within the container.

4. The method of claim 2, further comprising intercepting calls to the second servlet and delegating authentication of the calls by the Dev EAR to a monolith authentication service.

5. The method of claim 1, wherein the mocking subsystem is configured to provide responses mocking the services EAR when delegated to by the methods of the Dev EAR.

6. The method of claim 1, further comprising creating the Dev EAR client while developing the functionality of the Dev EAR as the mocking microservice; and
integrating the Dev EAR client into the monolith client in connection with enhancing the Dev EAR to run as the integrated microservice.

7. A method of monolith development using microservices, comprising:
creating a container including a coordinating Enterprise Archive (EAR), a Development EAR (Dev EAR), and a services EAR, the coordinating EAR including a first servlet to accept calls from a monolith client and being configured to delegate to both the development EAR and to the services EAR, the Dev EAR including a second servlet to accept calls from a Dev EAR client, the Dev EAR being configured to delegate to the services EAR;
developing functionality of the Dev EAR as a semi-integrated microservice independent of the coordinating EAR, the semi-integrated microservice having a set of methods configured to delegate to the services EAR while developing the functionality of the Dev EAR; and
after developing the functionality of the Dev EAR, enhancing the Dev EAR to run as an integrated microservice within the container to include the coordinating EAR.

8. The method of claim 7, wherein the second servlet is configured to accept calls from the Dev EAR client both during development of functionality of the Dev EAR and after the Dev EAR has been enhanced to run as the integrated microservice within the container.

9. The method of claim 8, wherein the second servlet is also configured to accept calls from the monolith client after the Dev EAR has been enhanced to run as the integrated microservice within the container.

10. The method of claim 8, further comprising intercepting calls to the second servlet and delegating authentication of the calls by the Dev EAR to a monolith authentication service.

11. The method of claim 7, wherein the services EAR is configured to execute functions when delegated to by the methods of the Dev EAR.

12. The method of claim 7, further comprising creating the Dev EAR client while developing the functionality of the Dev EAR as the semi-integrated microservice; and
integrating the Dev EAR client into the monolith client in connection with enhancing the Dev EAR to run as the integrated microservice.
